(19) United States
(12) Patent Application Publication
(10) Pub. No.: US 2010/0211464 A1
(43) Pub. Date: Aug. 19, 2010

(54) Targeted Online Advertising

(76) Inventors: Baojin Zhu, Hangzhou (CN); Qing Zhang, Hangzhou (CN); Hai Wang, Hangzhou (CN)

Correspondence Address: LEE & HAYES, PLLC, 601 W. RIVERSIDE AVENUE, SUITE 1400, SPOKANE, WA, 99201, US

(21) Appl. No.: 12/598,875

(22) PCT Filed: Nov. 6, 2008
(86) PCT No.: PCT/US08/82627

§ 371 Date: Nov. 4, 2009

(30) Foreign Application Priority Data
Nov. 7, 2007 (CN) 200710166433.4

(51) Int. Cl. G06Q 30/00

(52) U.S. Cl. 705/14.53

(57) ABSTRACT

A method of targeted online advertising provides to a user advertisements that meet the user preferences. The method stores user information of users, organize the users into user layers, identifies the stored user information of a visiting user based on a user identifier, and identify a target user layer associated with the visiting user. The method then determines a targeted advertisement type for the visiting user based on the favorite advertisement type of the target user layer and the user information of the current visiting user, and accordingly selects a targeted advertisement to be presented to the visiting user. The user information of the visiting user and the related user layer(s) are updated with the new user information including the records of the user's visit activities. The method provides targeted ads to users, and improves the click rates and the efficiency of the online advertisements.

### RELATED APPLICATIONS

The present application claims priority benefit of Chinese patent application No. 200710166433.4, filed Nov. 7, 2007, entitled “METHOD AND SYSTEM FOR TARGETED ONLINE ADVERTISING”, which Chinese application is hereby incorporated in its entirety by reference.

### BACKGROUND

The present disclosure relates to the fields of computer and Internet technologies, and particularly to methods and systems of targeted online advertising.

Currently, uninvited ads such as email spam, pop-up ads and plug-in ads are being gradually phased out because of their unpopularity among users. On the other hand, because of their ability to position advertising audience, targeted advertisement is becoming a major trend for current online advertisement.

“Targeted” refers to filtering of audience. With targeted advertisement, which advertisement is to be displayed depends on the visitor. Various targeting schemes can be provided. Targeted advertising may select different advertisements according to such information as business, geographical location and occupation of the visitors. Alternatively, the targeted advertising may display advertisements of different business natures based on different times in a day or a week. The targeted advertising may also select different advertisement formats based on the operating system or the browser used by a user. The goal is to improve the efficiency of online advertisement to the audience with targeted ads.

Existing methods of targeted advertising mainly have two types, namely search-based advertising and IP (Internet Protocol) segment advertising. Search-based advertising is a type of ad search based on searching for targeted ads that match a keyword. After a user enters search information, an advertising web server finds all types of advertisements that match the keyword entered by the user and displays these advertisements to the user. IP segment advertising refers to the type of advertisement in which an advertising web server acquires regional information from an IP address of a visitor and displays the advertisements that contain related regional information to the visitor.

Although existing technologies can provide user-related online advertisements to a certain extent, the advertising schemes do not consider conditions of each individual user and hence cannot provide to each individual user online advertisements that meet user preferences and fits the user identity.

### SUMMARY OF THE DISCLOSURE

Disclosed is a method of targeted online advertising for the purpose of providing to a user advertisements that meet user preferences and other personal characteristics. The method stores user information of users, organize the users into user layers, identifies the stored user information of a visiting user based on a user identifier, and identify a target user layer associated with the visiting user. The method then determines a targeted advertisement type for the visiting user based on the favorite advertisement type of the target user layer and the user information of the current visiting user, and accordingly selects a targeted advertisement to be presented to the visiting user. The user information of the visiting user and the related user layer(s) are updated with the new user information including the records of the user's visit activities. The method provides targeted ads to users, and improves the click rates and the efficiency of the online advertisements. Typically, an advertisement is displayed in an advertisement presented by a browser.

In one embodiment, the targeted advertisement is randomly selected from multiple advertisements of the favorite advertisement type of the target user layer. In another embodiment, the user information, including both the previously stored and the recently received or collected, are used to select a more targeted advertisement from the multiple advertisements of the favorite advertisement type of the target user layer.

In another aspect of the disclosure, a system of targeted online advertising is disclosed. In particular, the computer system having a processor and a computer readable media for storing the user information and computer-executable instructions is used to realize the method of targeted online advertising disclosed herein.

According to various exemplary embodiments, the method and system analyze and mine the recorded or received user information of the visiting user and determine a targeted advertisement type for the present visit of the visiting user. The advertisement website returns an online targeted advertisement of the targeted advertisement type to the user's browser, thus providing targeted advertisement that meets the preferences and the identity of the user and improves the click rate and the efficiency of the online advertisements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a flow chart of an exemplary user layering process for dividing visitors (users) of an advertisement website into multiple user layers in accordance with the present disclosure.

FIG. 2 shows a flow chart of an exemplary targeted online advertising to a user visiting an advertisement website.

FIG. 3 shows a schematic diagram of a system of targeted advertisement in accordance with the present disclosure.

FIG. 4 shows an exemplary environment for implementing the method of the present disclosure.

### DETAILED DESCRIPTION

According to the exemplary embodiments of the present disclosure, the targeted advertising method divides users (visitors) of an advertisement website into user layers and records information of favorite advertisement type(s) and the related advertisements of each user layer. Upon receiving an access request of a visiting user, the advertisement website performs identity verification for the user. If the advertisement website is able to identify the visiting user and the associated user information, the advertisement website analyzes the user information, determines a user layer to which the user belongs, and finds one or more favorite advertisement types of the user layer. Based on the favorite advertisement types obtained, the advertisement website further performs mining of the user information of the visiting user and determines a targeted advertisement type for present visit of the visiting user. The advertisement website returns an advertisement (i.e., advertisement web page) of the targeted advertisement type to a browser of the visiting user. This method allows the visiting users of the advertisement website be accurately positioned and provides an advertisement type that meets user's identity and preferences, thus potentially improving the click rate and the efficiency of online advertisement.

Furthermore, according to an exemplary embodiment, the method records related information of the present visit of the visiting user. Examples of related information are the time of the present visit and the contents of the web pages visited by the visiting user. Some exemplary embodiments of the method also record whether the user has clicked on the targeted advertisement displayed by the advertisement website, and the length of the time the visiting user has stayed on the advertisement, and uses such recorded information as one of the bases to determine the next targeted advertisement type, for the current visit and the next visit of the visiting user to this advertisement website. This enables the targeted online advertising of the present disclosure to learn more about the user based on the user activities, and further ensures the effectiveness of targeted online advertising.

An exemplary process of layering or dividing the users into user layers is based on value range(s) of one or more properties in the user information of the users who visit an advertisement website, or the value range(s) of one or more properties derived from related data provided by a third party. The data provided by the third party may include such information as demographic statistics, consumer habits and characteristics of Internet users.

The layering may have multiple granularity levels, each granularity level representing a degree of division of the users into multiple user layers. Granularity of the user layers can be selected according to practical needs, ranging from placing all users into a single user layer to dividing the users into the smallest user layers each including only one user. With the extreme in which the users are divided into single-user layers, true individualized advertising for users may be achieved. But various intermediate levels of granularity place to achieve targeted advertising to various extents.

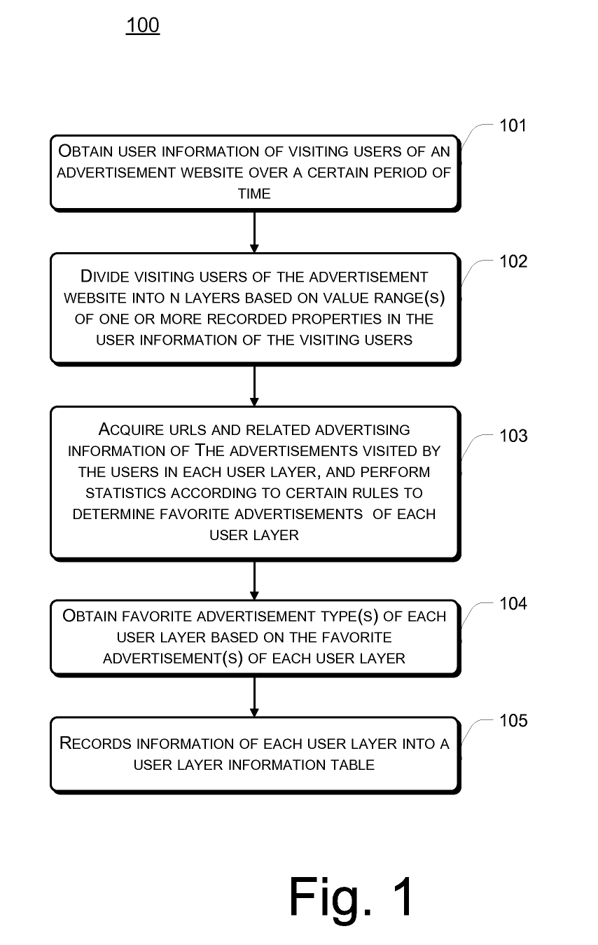

FIG. 1 shows an exemplary process of dividing users into user layers based on user information of the users. In this description, the order in which a process is described is not intended to be construed as a limitation, and any number of the described process blocks may be combined in any order to implement the method, or an alternate method.

The exemplary process 100 of FIG. 1 is performed by a targeted advertising system which is supports an advertisement website hosting advertisements. An example of such an advertisement website is an e-commerce site advertising and selling various products. Another example of such an advertisement website is a content website (such as a news website or an online service website) which carries third-party advertisements. The exemplary process is described as follows.

At block 101, the targeted advertising system obtains user information of the users who have visited the advertisement website during a certain period of time. In one embodiment, the user information of the users is stored in the targeted advertising system. The user information may be submitted by the users to the advertisement website, obtained through collection and analysis by the advertisement website. Alternatively, at least part of the user information may be obtained from a third-party information provider. In the latter, the users may include both those who have visited the advertisement website in the past and those who are expected to visit the advertisement website.

At block 102, the targeted advertising system divides the users into N layers based on value range(s) of one or more properties recorded in the user information. The properties may be characteristics of the user (e.g., a user identifier and age) and user behavioral or activity properties in relation to the advertisement website (such as contents of web pages browsed by a user and the times of visit of the website by the user).

For example, assume one hundred users visited the advertisement website during a certain period of time, and the user information of each user contains such information as gender and age of the user. Suppose the statistics shows that out of these one hundred users, there are seventy females of age between fifteen and thirty, five females of age over thirty, and twenty-five males of age between ten and twenty. In an exemplary layering scheme, the hundred users are divided into three layers based on two properties (i.e., gender and age of the user). The first layer includes females of age between fifteen and thirty, the second layer includes females of age over thirty, and the third layer includes males of age between ten and twenty.

At block 103, the targeted advertising system acquires URLs (Uniform Resource Locator) of the advertisements that the users have visited through the advertisement website and related advertising information for each user layer, computes statistics of the acquired information according to certain rules, and determines one or more favorite advertisement types of each user layer.

Take the user layer of females of age over thirty in the previous example as an illustration. Relevant records of online advertisements of the advertisement website visited by the users are acquired from the user information of each user and processed in such a way to obtain statistical information of behaviors of the user layer with respect to visiting the online advertisements. The statistical information is shown in TABLE 1 below.

TABLE 1
Recorded User Behaviors of the User Layer of Females of
Age over 30 Visiting the Online Advertisements

| User | | | | | | |
|---|---|---|---|---|---|---|
| ID | Ad 1 | Ad 2 | Ad 3 | . . . | Ad N | Ad N + 1 |
| A1 | Y | | | . . . | | |
| A2 | | Y | Y | . . . | | Y |
| A3 | | Y | Y | . . . | Y | |
| A4 | | Y | | . . . | | |
| A5 | Y | Y | Y | . . . | | |

The above TABLE 1 shows the behavior of five users of user IDs A1, A2, A3, A4 and A5 visiting online advertisements identified as Ad 1, Ad 2, Ad 3, . . . Ad N, and Ad N+1. The recorded behavioral information is analyzed to obtain a favorite advertisement of the user layer. For example, the favorite advertisement of the user layer in the above table can be obtained using the following procedure:

From the records in TABLE 1, it is seen that Ad 2 has four visitors out of five, and thus has a relevancy of 4/5. Likewise, the relevancy of Ad 3 is 3/5, and the relevancy of Ad 1 is 2/5. Accordingly, the advertisements of the user layer given in a descending order of the user preference (favorite) are: Ad 2, Ad 3, Ad 1, Ad N, and Ad N+1. Therefore, Ad 2 is the advertisement most visited (favored) by the users in the user layer, followed by Ad 3, and so forth. A2 is therefore considered a favorite advertisement of this user layer.

Besides the above statistical algorithm, additional factors of consideration can be added when computing the favorite advertisement of the user layer. One example is the time spent by the user on the visited advertisement.

At block 104, the targeted advertising system obtains a favorite advertisement type of each user layer based on the favorite advertisement of each user layer. For example, if the above favorite advertisement A2 belongs to a certain advertisement type, it may be concluded that this advertisement type is a favorite advertisement type of the related user layer.

At block 105, the targeted advertising system records the information of each user layer into a user layer information table. An exemplary record of user layer information may include information such as a user layer ID, variables and properties of the user layer, favorite advertisement type(s) of the user layer, and URLs of advertisements and contents of the advertisements that are included in each advertisement type.

In this example, the finalized user layer information table may take the following form:

TABLE 2
User Layer Information Table

| User Layer | | | Advertisement | Advertisement | Advertisement | |
|---|---|---|---|---|---|---|
| ID | Gender | Age | Type | URL | Content | . . . |
| 001 | F | 15-30 | Fashion Jewelry | Ad 5 | Black Swan | |
| | | | | | Mickey Pendant | |
| | | | | . . . | | |
| 002 | F | >30 | Luxury | Ad 2 | Guerlain | |
| | | | Cosmetics | | Aquaserum | |
| | | | | . . . | | |
| | | | Home Fabrics | Ad 3 | Creative Home | |
| | | | | | Bag | |
| | | | | . . . | | |
| 003 | M | 10-20 | Fashion Watches | Ad 8 | LG72 Men's | |
| | | | | | Watch | |
| | | | | . . . | | |

When the advertisement website receives an access request from a visiting user, the targeted advertising system searches for a user layer to which the user belongs and determines favorite advertisement type(s) of the identified user layer. Based on the user information of the visiting user, the advertisement website further determines a targeted advertisement type for the present visit of the visiting user to achieve targeted online advertising for the visiting user. This process is further illustrated below.

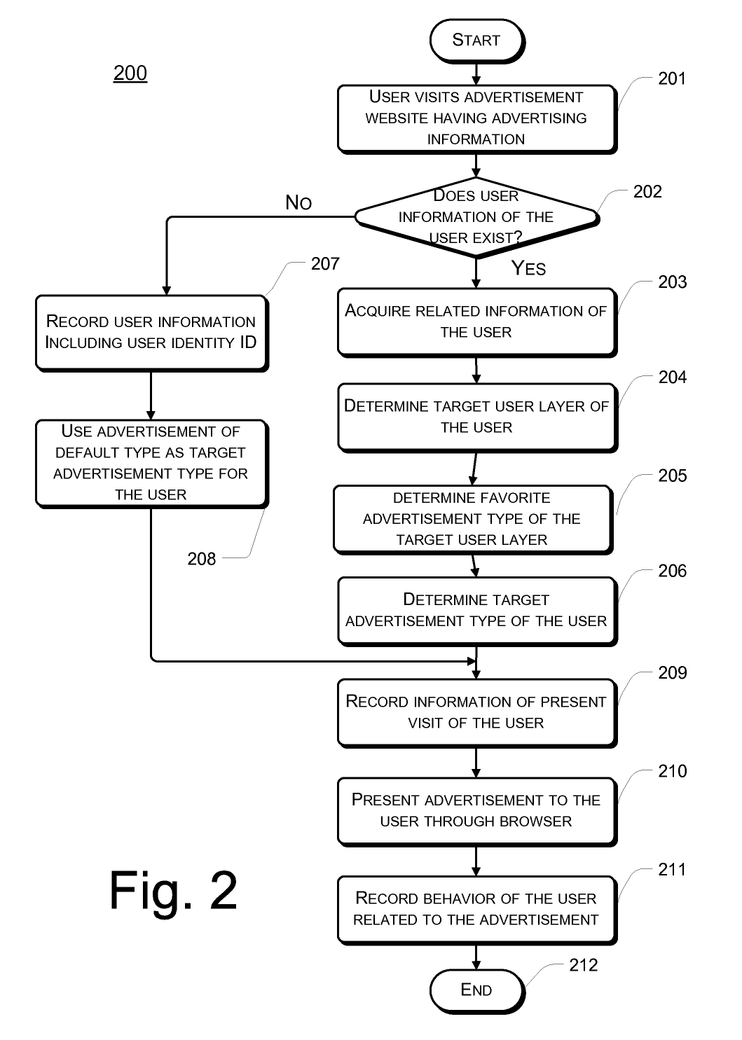

FIG. 2 shows a flow chart of targeted online advertising to a visiting user of an advertisement website. The targeted online advertising is performed by a targeted advertising system which supports or hosts an advertisement website. The targeted online advertising process 200 may be understood with the above TABLE 2 as an exemplary background.

At block 201, an advertisement website receives an access request of a visiting user. The access request of the user may either an explicit logon request, or a regular visits by the user browsing the advertisement website.

At block 202, the targeted advertising system determines whether the user information of the visiting user exists in its stored user information, which is typically stored in a database.

If the visiting user has come to the advertisement website through an explicit logon, the advertisement website would be able to identify the user through the user's logon information. If the user is just browsing the advertisement website, the advertisement website determines whether there is a user identifier contained an information file sent along with the access request. An example of such information file is a cookie file from the user's local machine. A cookie file is an information file sent along by a web page to a browser of a user when the user visits a website. After the user completes browsing of the website, the browser of the user saves the file into a local drive of the user to be used in the next visit of the website by the user.

Lack of any user identifying information may indicate that it is the first time for the user to visit the advertisement website and no user identifier has been given to the user before. The advertising system thus assigns a unique user identifier to the user and inserts it into a cookie file of the user. The process then goes to block 207.

If a cookie file is sent along with the request, it indicates that the user has visited the advertisement website in the past and the cookie file can be used to determine whether a user identifier was recorded. If not, a unique ID is assigned to the user and inserted into the cookie file of the user. The process proceeds to block 207. If a user identifier is found in the cookie file, the user identifier is acquired from the cookie file by the targeted advertising system. The advertising system then searches for stored user information that has the matching user identifier. If no such user information is found by the advertisement website, the process proceeds to block 207. But if user information that has the user identifier is found, the process continues to block 203.

At block 203, the targeted advertising system reads the stored user information of the user according to the user identifier. The stored user information may have been provided by the user upon visiting the website or collected by the website, and may include such information as gender, age, place of birth, address, educational background and salary range. The user information may also include information of the user activities such as the types of the recently purchased products, the advertisements visited by the user, the times spent by the user on the advertisements visited, whether the user has clicked on a certain advertisement, and content of last visited web page of the advertisement website.

At block 204, the targeted advertising system determines a user layer to which the visiting user belongs. The user information of the visiting user contains values of multiple properties used for characterizing the user. At the same time, each user layer is defined by a set of delimiting conditions, which in one example are based on ranges of the values of a set of properties derived from the user information of the users. Based on the values of the properties in the user information of the visiting user, and the ranges of the values of the properties that define user layers, the targeted advertising system determines a user layer whose delimiting conditions are satisfied by the property values of the user information of the visiting user, and concludes that the visiting user belongs to the user layer. The user layer is thus chosen as a target user layer.

An example of the stored user information is shown in TABLE 3.

TABLE 3
User Information of the Users

| User ID | Gender | Age | Address | Advertisement last visited | . . . |
|---|---|---|---|---|---|
| 000101 | F | 24 | Beijing | Bang Bang Wa Beef Jerky | . . . |
| 000102 | F | 36 | | | . . . |
| . . . | . . . | . . . | . . . | . . . | . . . |

In one example, the above analysis concludes that the user with ID 000101 belongs to the user layer with user layer ID 001 in TABLE 2, while the user with ID 000102 belongs to the user layer with user layer ID 002 in TABLE 2.

At block 205, the targeted advertising system uses the obtained target user layer of the visiting user to determine favorite advertisement type(s) of that user layer. Using the previous example, by looking up the TABLE 2, the advertising system determines that the favorite advertisement type of the target user layer (ID 001) of the user of ID 000101 is “fashion jewelry”, and the favorite advertisement types of the user layer (ID 002) of the user of ID 000102 are “luxury cosmetics” and “home fabrics”.

At block 206, the targeted advertising system determines a targeted advertisement type for the target user based on the favorite advertisement type(s) of the target user layer and the user information of the visiting user. In one embodiment, the user information of the visiting user is used to further narrow down from the advertisement type of the target user layer to provide even more focused advertisement type to the visiting user.

If little user information of the visiting user is available, the identified favorite advertisement type of the target user layer of the visiting user may be taken as the targeted advertisement type for the present visit of the visiting user. For example, in the previous table, fashion jewelry is the favorite advertisement type of the user layer of the user of ID 000101, and this advertisement type is then set as the targeted advertisement type of the present visiting user.

If sufficient relevant user information of the user is available, the user information of the visiting user, together with the favorite advertisement type of the target user layer of the visiting user, are mined and analyzed to determine a more focused targeted advertisement type of the user. For instance, assume that the recorded information of browsing behavior and habits of the visiting user in the target user layer of ID 002 shows that the user did not click on any advertisements of cosmetics but has visited a type of advertisements related to snacks. In this case, the specific user behavioral information indicating a favorite advertisement type of the visiting user may be given more weight, while the favorite advertisement type of the target user layer may be given less weight, as a balanced consideration to determine a final recommendation of the favorite advertisement type(s) for the visiting user. The favorite advertisements may be ordered or reordered according to the balanced weights to obtain a targeted online advertisement that the user will most likely visit. After this, the process proceeds to block 209, which is described below after the two side blocks 207 and 208 have been first described.

At block 207, the targeted advertising system records the user information of the visiting user who has not been identified by the system in the existing stored user information. The content recorded in this block may include such information as a user identifier of the user and the IP address of the user.

At block 208, the targeted advertising system sends a default advertisement to the browser of the user. Since there is little or none information available to identify the characteristics or of the present visiting user, a generic default advertisement may be provided to the user. However, if some clue exists with respect to the visiting user, at least to some limited targeting, such as that based on the IP address, may still be performed.

At block 209, the advertising system records the information of the present visit of the visiting user. The recorded information can be seen as new user information in addition to the stored user information. The content recorded here may include such information as the IP of the user, and contents of the web pages visited by the user during the present visit, and the time of the visit. Geographical location of the user may be determined by the IP address of the user. Such recorded new user information may be used, in addition to the stored user information, as one of the bases to determine the targeted advertisement type of the visiting user.

The user's browsing activities during the present visit refer to those Web activities that may not be related to the targeted advertisement presented to the user. In general, a website such as the advertisement website herein is able to follow and a monitor a user's browsing activities once an Internet session is established between the website and the user. The information of such browsing activities may be used as a basis for determining the targeted advertisement type of the visiting user. For example, if the content of a web page browsed by the user during the present visit is related to news about vehicles, “vehicle” is recorded as one of the products that the user is interested in.

In one embodiment, the above recorded information of the present visit is used to update the user information of the user stored at the advertisement website, to also contribute to the determination of the targeted advertisement type of the next visit of the visiting user. If no stored user information is associated with the visiting user, the recorded visit information may be used for establishing a record of such user information.

At block 210, the targeted advertising system sends via the advertisement website a targeted advertisement chosen from the advertisement type to the browser of the user. At this point, if no further information available to further target the visiting user, the targeted advertisement may be chosen randomly from the available advertisements of the targeted advertisement type so far identified for the visiting user. For example, based on the targeted advertisement type obtained, the targeted advertising system may check the record of the TABLE 2 and randomly selects an online advertisement of the targeted advertisement type of the target user layer. An online advertisement may be identified by its URL. The advertisement website then sends the selected targeted advertisement to the browser of the user.

At block 211, the advertisement website records information of the user activities related to the targeted advertisement, such as the information of the visiting user's activities of selecting and viewing the targeted advertisement. Such information is another example of new user information which can be used, in addition to the stored user information, to select the targeted advertisement type. The recorded activity information may be used to update the user information of the visiting user. If no stored user information is associated with the visiting user, the recorded activity information may be used for establishing a record of such user information.

The recorded activity information may include whether the user clicks on the targeted advertisement presented to the user. The content being recorded may include such information as the URLs, the types and the products of the targeted online advertisement and other related advertisements, the viewing time of the targeted advertisement and, if available, the purchase activities following the advertisement. If relevant record exists in the stored user information of the visiting user, the original record is updated by the new information.

At block 212, the current session of targeted advertising to the visiting user ends. This usually occurs when the visiting user leaves the advertisement website.

It is noted that in the above illustrated process, information related to the user, including the information received from the user, the information of the browsing activities of the user during the present visit, and the information of the user activities related to the targeted advertisement presented to the user, may all be recorded and used to update the stored user information of the visiting user. The updated user information is then used to update the related user layers and their favorite advertisement types. The updated user information and user layer information is then made available for the next visit of the visiting user and any other user.

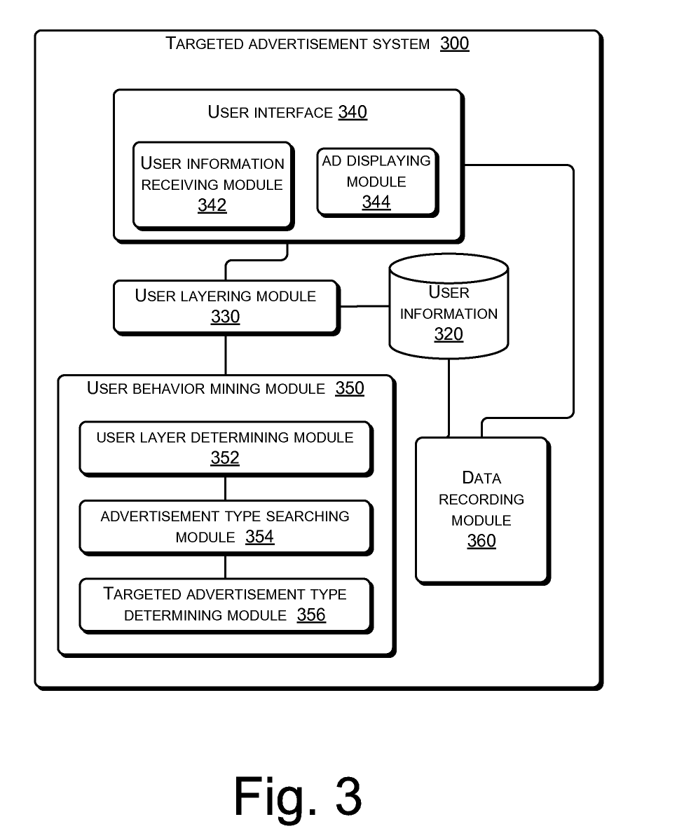

FIG. 3 shows a schematic diagram of targeted advertisement system in accordance with the present disclosure.

In the targeted advertising system 300, a storage device 320 is used for storing user information of users who have visited or may visit an advertisement website supported by the targeted advertising system 300. The user information of each user includes at least one of a user identifier, personal information and behavioral information of the user. The behavioral information of each user includes the user's activities of selecting and viewing webpages and advertisements.

A user layering module 330 is used for layering the users into a plurality of user layers each including at least one user. Each user layer is defined by a set of delimiting conditions regarding values of a set of properties related to the user information.

A user interface 340 includes a user information receiving module 342 for receiving user information of a visiting user, and an ad display module for presenting advertisements to the visiting user.

A user behavior mining module 350 has a user layer determining module 352 for identifying from the plurality of user layers a target user layer to which the current visiting user belongs; an advertisement type searching module 354 for identifying the favorite advertisement type of the target user layer; and a targeted advertisement type determination module 356 for searching and selecting a targeted advertisement type for the present visit of the visiting user. The determination of the targeted advertisement type is at least partially based on one or a combination of the following: the favorite advertisement type of the target user layer; the current user information of the current visiting user; and the stored user information associated with the current visiting user.

A recording module 360 is used for recording information of the current visiting user's present visit and the current visiting user's activities of selecting and viewing the targeted advertisement. The current visiting user's present visit information may include the browsing activities of the user during the present visit. The current visiting user's activities of selecting and viewing the targeted advertisement may include information regarding whether the current visiting user has clicked on the presented targeted advertisement, and length of time that the current visiting user has stayed on the presented targeted advertisement.

The information recorded by the recording module 360 is used to update the user information stored in the data storage 320. If the user information of the user does not already exist in the user information stored in the data storage 320, the recording module 360 may further establish a record of the user information of the visiting user using the newly recorded information. The user information being established may include a user identifier of the user.

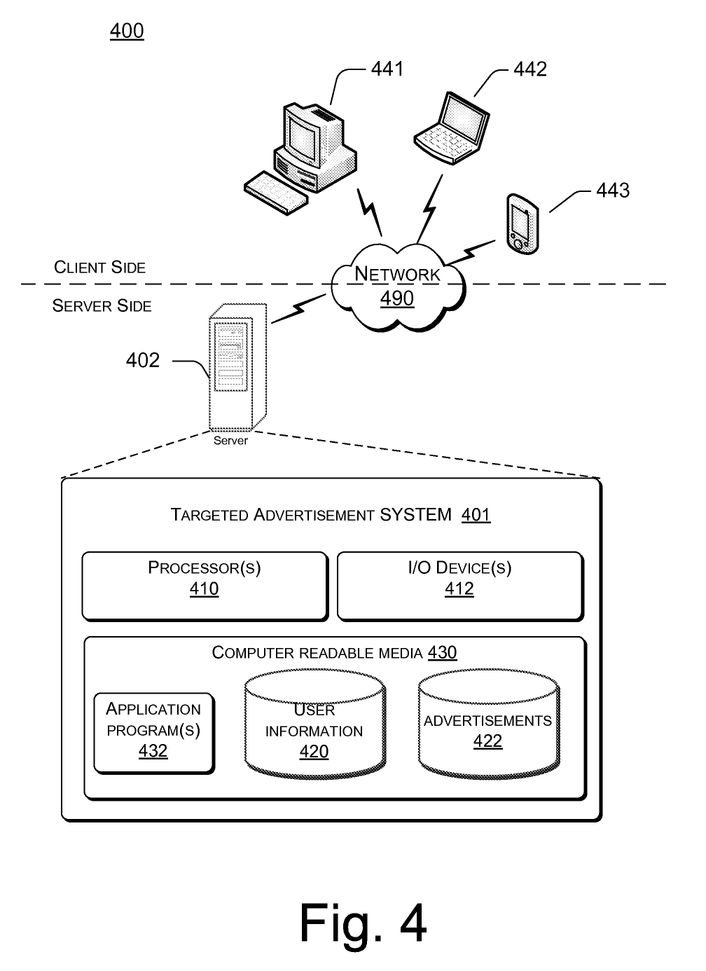

FIG. 4 shows an exemplary environment for implementing the method of the present disclosure. In the illustrated system 400, some components reside on a client side and other components reside on a server side. However, these components may reside in multiple other locations. Furthermore, two or more of the illustrated components may combine to form a single component at a single location.

Targeted advertisement system 401 is implemented with a computing device 402 which is preferably a server and includes processor(s) 410, I/O devices 412, computer readable media 430, and network interface (not shown). The computer device 402 is connected to client-side computing devices (client terminals) such as 441, 442 and 443 through network(s) 490. In one embodiment, computing device 402 is a server, while client-side computing devices 441, 442 and 443 may each be a computer or a portable device, used as a user terminal.

The computer readable media 430 stores application program modules 432, user information 420 and advertisements 422. Application program modules 432 contain instructions which, when executed by processor(s) 410, cause the processor(s) 410 to perform actions of a process described herein (e.g., the illustrated processes of FIGS. 1-2). In an exemplary embodiment, the instructions, when executed, cause the processor 410 to:

layer the plurality of users into a plurality of user layers each including at least one user, each user layer being defined by a set of delimiting conditions regarding values of a set of properties related to the user information;

determine a favorite advertisement type of each user layer;

receive a current user information of a current visiting user;

identify from the plurality of user layers a target user layer to which the current visiting user belongs according to the current user information of the visiting user;

select a targeted advertisement at least partially based on one or a combination of the favorite advertisement type of the target user layer, the current user information of the current visiting user, and stored user information associated with the current visiting user; and

present the targeted advertisement to the current visiting user.

It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. Especially, computer device 402 may be a server computer, or a cluster of such server computers, connected through network(s) 490, which may either be Internet or an intranet.

According to the exemplary embodiments described above, the targeted advertisement system divides users (visitors) into user layers to allow displaying favorite advertisements of users in a user layer according to user preferences. Upon receiving an access request of a user, the advertisement website determines a user layer of the visiting user, looks up the favorite advertisement type of the user layer, and then uses the advertisement type of the user layer to further analyze the user information of the visiting user to determine a targeted advertisement type for the present visit of the user. The advertisement website sends a targeted advertisement of the targeted advertisement type to a browser of the user to be displayed. The advertising is thus based on practical conditions of the user and provides each user advertisements that satisfy individual preferences to improve the click rate of online advertisement. The targeted advertising system can also predict favorite advertisement types of the users of a user layer based on the browsing and clicking behaviors of one or more users of the same user layer to achieve targeted advertising. Furthermore, based on recorded information of each user, individualized advertising for each user may be achieved.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method of targeted online advertising, the method comprising:
providing stored user information of a plurality of users, the stored user information of each user including at least one of a user identifier, personal information and behavioral information of the user, the behavioral information of each user including the user's activities of selecting and viewing advertisements or webpages;
layering the plurality of users into a plurality of user layers each including at least one user, each user layer being defined by a set of delimiting conditions with respect to values of a set of properties related to the stored user information;
determining a favorite advertisement type of each user layer;
receiving a current user information of a current visiting user;
identifying from the plurality of user layers a target user layer to which the current visiting user belongs according to the current user information of the visiting user;
selecting a targeted advertisement at least partially based on one or more of the favorite advertisement type of the target user layer, the current user information of the current visiting user, and the stored user information associated with the current visiting user; and
presenting the targeted advertisement to the current visiting user.

2. The method as recited in claim 1, wherein selecting the targeted advertisement comprises:
randomly selecting an advertisement from multiple advertisements of the favorite advertisement type of the target user layer to be the targeted advertisement.

3. The method as recited in claim 1, wherein selecting the target advertisement comprises:
selecting a user-favored advertisement from multiple advertisements of the favorite advertisement type of the target user layer to be the targeted advertisement.

4. The method as recited in claim 1, further comprising:
determining a user identifier from the current user information of the current visiting user; and
identifying the current visiting user among the plurality of users according to the user identifier of the current visiting user.

5. The method as recited in claim 4, further comprising:
updating the stored user information of the current visiting user using the current user information of the current visiting user; and
updating the favorite advertisement type of the target user layer using the current user information of the current visiting user.

6. The method as recited in claim 1, further comprising:
recording information of the current visiting user's present visit, the information including user activities of browsing webpages during the present visit;
updating the stored user information of the current visiting user using the recorded information of the current visiting user's present visit; and
updating the favorite advertisement type of the target user layer using the recorded information of the current visiting user's present visit.

7. The method as recited in claim 6, wherein the recorded information of the current visiting user's present visit includes time of the present visit and contents of the webpages visited by the current visiting user during the present visit.

8. The method as recited in claim 1, the method further comprising:
recording information of the current visiting user's activities of selecting and viewing the targeted advertisement; and
updating or establishing user information of the current visiting user using the recorded information.

9. The method as recited in claim 1, wherein, if there is no stored user information associated with the current visiting user, the method further comprises:
saving the current user information of the current visiting user, the current user information of the current visiting user including at least one of a user identifier, personal information and behavioral information of the current visiting user.

10. The method as recited in claim 1, wherein, if the current user information is insufficient to identify the current visiting user, the method further comprises:
sending a default advertisement to the current visiting user.

11. The method as recited in claim 1, wherein the stored user information of the plurality of users is a result of recording user information of the plurality of users over a period of time.

12. The method as recited in claim 1, wherein the sets of delimiting conditions of the plurality of user layers are determined based on ranges of the values of the set of properties derived from the stored user information.

13. The method as recited in claim 1, wherein the sets of delimiting conditions of the plurality of user layers are determined based on ranges of the values of the set of properties derived from data provided by a third party, wherein the data provided by the third party includes information of population statistics, consumer habits and characteristics of Internet users.

14. The method as recited in claim 1, wherein each user layer is identified with a user layer ID, and the favorite advertisement type of each user layer is characterized by an advertisement type identifier and URLs and contents of one or more advertisements of the favorite advertisement type.

15. The method as recited in claim 1, wherein the plurality of user layers has a plurality of granularity levels.

16. The method as recited in claim 15, wherein the target user layer of the current visiting user has the finest granularity identifiable based on the stored user information and the current user information of the current visiting user.

17. A system of targeted online advertising, the system comprising:
a storage device for storing stored user information of a plurality of users, the stored user information of each user including at least one of a user identifier, personal information and behavioral information of the user, the behavioral information of each user including the user's activities of selecting and viewing advertisements;
a user layering module for layering the plurality of users into a plurality of user layers each including at least one user, each user layer being defined by a set of delimiting conditions regarding values of a set of properties related to the stored user information;
a user interface for receiving a current user information of a current visiting user; and
a user behavior mining module for identifying from the plurality of user layers a target user layer to which the current visiting user belongs according to the current user information of the visiting user, determining a favorite advertisement type of the target user layer, and selecting a targeted advertisement type for the current visiting user at least partially based on one or a combination of the favorite advertisement type of the target user layer, the current user information of the current visiting user, and stored user information associated with the current visiting user,
wherein the user interface is further used for presenting the targeted advertisement to the current visiting user.

18. The system as recited in claim 17, further comprising:
a recording module for recording information of the current visiting user's present visit and the current visiting user's activities of selecting and viewing the targeted advertisement.

19. A system of targeted online advertising, the system comprising a processor and one or more computer readable media, wherein the one or more computer readable media have stored thereon stored user information of a plurality of users, the stored user information of each user including at least one of a user identifier, personal information and behavioral information of the user, the behavioral information of each user including the user's activities of selecting and viewing advertisements or webpages, and wherein the one or more computer readable media have further stored thereupon a plurality of instructions that, when executed by the processor, causes the processor to:
layer the plurality of users into a plurality of user layers each including at least one user, each user layer being defined by a set of delimiting conditions regarding values of a set of properties related to the user information;
determine a favorite advertisement type of each user layer;
receive a current user information of a current visiting user;
identify from the plurality of user layers a target user layer to which the current visiting user belongs according to the current user information of the visiting user;
select a targeted advertisement at least partially based on one or a combination of the favorite advertisement type of the target user layer, the current user information of the current visiting user, and the stored user information associated with the current visiting user; and
present the targeted advertisement to the current visiting user.
